(19) United States
(12) Patent Application Publication
(10) Pub. No.: US 2026/0038370 A1
(43) Pub. Date: Feb. 5, 2026

(54) Intelligent Vehicle Control and Routing

(71) Applicant: T-Mobile Innovations LLC, Overland Park, KS (US)

(72) Inventor: Lyle W. PACZKOWSKI, Mission Hills, KS (US)

(21) Appl. No.: 18/792,544

(22) Filed: Aug. 1, 2024

(51) Int. Cl. G08G 1/0968; B60W 30/16; G01C 21/34

(52) U.S. Cl. CPC G08G 1/096816; B60W 30/16; G01C 21/3461; G01C 21/3492; B60W 2720/30

(57) ABSTRACT

A method. The method comprises analyzing historical information about motor vehicles driving over roads by an application executing on a computer system; analyzing current environmental conditions experienced by a monitored motor vehicle by the application; based on analyzing the historical information about motor vehicles driving over roads, based on analyzing current environmental conditions, determining an operating parameter change for the monitored motor vehicle by the application; and transmitting the operating parameter change by the application to the monitored motor vehicle via a network, whereby the control of the vehicle is adapted based on current environmental conditions and historical information about motor vehicles driving over roads.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Motor vehicles may feature an on-board computer system in the vehicle that monitors and at least partly controls various systems of the vehicle. This on-board computer system may be referred to as a telematics unit. A telematics unit may monitor systems of the vehicle in real-time and store data related to the vehicle and/or its environment. The telematics unit may set operational parameters of the vehicle, for example a maximum speed or the vehicle, a maximum rate of acceleration of the vehicle, and/or other operational parameters.

### SUMMARY

In an embodiment, a method of augmenting control of a motor vehicle based on driving conditions and conditions of a radio access network (RAN) is disclosed. The method comprises analyzing historical information about motor vehicles driving over roads by an application executing on a computer system, wherein the historical information comprises identities of cell sites that telematics units in the motor vehicles wirelessly attached to, uplink channel bandwidth of the cell sites, and downlink channel bandwidth of the cell sites; analyzing current environmental conditions experienced by a monitored motor vehicle by the application, wherein the current environmental conditions are retrieved from temperature monitor stations, from humidity monitor stations, barometric pressure monitor stations, and from weather forecast feeds; and analyzing conditions of the RAN within a predetermined radius of the monitored motor vehicle by the application. The method further comprises, based on a predefined destination of the monitored motor vehicle, based on analyzing the historical information about motor vehicles driving over roads, based on analyzing current environmental conditions, and based on analyzing conditions of the RAN, determining a preferred driving route for the monitored motor vehicle by the application; and transmitting information about the preferred driving route by the application via the RAN to the monitored motor vehicle, whereby the monitored motor vehicle is enabled to reach its destination while remaining in RAN coverage based on the transmitted information about the preferred driving route.

In another embodiment, a system for augmenting control of a motor vehicle based on driving conditions and radio access network (RAN) conditions is disclosed. The system comprises a processor; a non-transitory memory; and an application stored in the non-transitory memory. When executed by the processor, the application analyzes historical information about motor vehicles driving over roads by an application executing on a computer system; analyzes current environmental conditions experienced by a monitored motor vehicle by the application; and analyzes radio access network (RAN) conditions by the application. The application further, based on a predefined destination of the monitored motor vehicle, based on analyzing the historical information about motor vehicles driving over roads, based on analyzing current environmental conditions, and based on analyzing RAN conditions, determines a preferred driving route for the monitored motor vehicle by the application; and transmits information about the preferred driving route by the application via the RAN to the monitored motor vehicle, whereby the monitored motor vehicle is enabled to reach its destination while remaining in RAN coverage.

In yet another embodiment, a method is disclosed. The method comprises analyzing historical information about motor vehicles driving over roads by an application executing on a computer system and analyzing current environmental conditions experienced by a monitored motor vehicle by the application. The method further comprises, based on analyzing the historical information about motor vehicles driving over roads, based on analyzing current environmental conditions, determining a operating parameter change for the monitored motor vehicle by the application and transmitting the operating parameter change by the application to the monitored motor vehicle via a network, whereby the control of the vehicle is adapted based on current environmental conditions and historical information about motor vehicles driving over roads.

In yet another embodiment, a method of augmenting control of a motor vehicle based on driving conditions and conditions of a radio access network (RAN) is disclosed. The method comprises analyzing historical information about motor vehicles driving over roads by an application executing on a computer system and analyzing current environmental conditions experienced by a monitored motor vehicle by the application. The method further comprises, based on analyzing the historical information about motor vehicles driving over roads, based on analyzing current environmental conditions, determining an operating parameter change for the monitored motor vehicle by the application; and transmitting the operating parameter change by the application to the monitored motor vehicle via the RAN, whereby the control of the vehicle is adapted based on current environmental conditions and historical information about motor vehicles driving over roads.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a flow chart of a method according to an embodiment of the disclosure.

FIG. 3 is a flow chart of another method according to an embodiment of the disclosure.

FIG. 4A and FIG. 4B are a block diagram of an exemplary communication network according to an embodiment of the disclosure.

FIG. 5 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The present disclosure teaches a system for augmenting control of a motor vehicle via a telecommunication network. Because the cellular wireless network is nearly ubiquitous, it can collect data from motor vehicles across diverse areas, build a data store from the data, analyze the data, and draw inferences from the analyzed data that can be used to provide augmented control signals to motor vehicles in near real-time. For example, at a given location—for example a small town in Kansas in July—the system can (1) determine that it has not rained for four weeks, (2) determine that rain is starting to fall in parts of the town, (3) infer that due to the long period of dry weather oil has accumulated on the surface of roads in the town, (4) infer that recently emulsified oil (oil accumulated on the road emulsified by the onset of rain) is likely to make the roads in the town very slippery, and (5) send a control recommendation to one or more motor vehicles operating in the town to further restrict speed limits or wheel torque limits automatically imposed by a computer control system internal to the vehicles (e.g., by a telematics unit).

It will be appreciated that the system may not reach the point of issuing this control recommendation according to the human narrative of thinking described above, which is provided to help visualize and appreciate the workings of the process, but instead by a machine learning (ML) model process that processes a large number of different inputs and determines the control recommendation accordingly. The system may determine a duration of a dry period by monitoring and storing data on local weather reports. Alternatively, the system may determine a duration of a dry period by noting the absence of inputs from motor vehicles indicating the vehicle has sensed moisture on its windshield (e.g., automatic windshield wiper systems detect water droplets). The system may determine rain is starting based on monitoring local weather forecasts. Alternatively, the system may determine rain is starting based on receiving inputs from motor vehicles indicating the vehicle has sensed moisture on its windshield. The system may be programmed with a rule that associates rain after a long dry period with slippery road conditions. Alternatively, the system, using ML methods, may analyze data that indicates the correlation between rain after a long dry period with wheel skid inputs from vehicles while undergoing normal wheel torque regimes not associated with skidding and make the correlation between rain after a long dry period with decreased road traction immediately after rain onset.

The system may send a variety of different control recommendation inputs to motor vehicles, for example maximum vehicle speed limits, wheel torque limits, engine RPM limits, a drive gear recommendation, vehicle separation minimums (minimum distance to maintain from a vehicle in front of the subject vehicle for a given speed), maximum angular acceleration (e.g., turning speed). These control recommendation inputs may be received by a telematics unit of a given vehicle via the cellular network, and the telematics unit may reconfigure corresponding vehicle control parameters in various systems of the vehicle. Because these are deemed control recommendations, the telematics unit and/or the driver of the vehicle may choose to override or ignore them. On the other hand, if the telematics unit and the driver accede to the control recommendation inputs, in many cases the driving safety of the vehicle can be increased. These control recommendations may be considered to augment the control functions of the telematics unit or other automated control systems of the vehicle.

One of the control recommendations that the system transmits via the cellular network to the vehicle may be a recommended driving route or a portion of a recommended driving route. The system may learn, for example from a navigation system of the vehicle, what the driving destination is. The system may determine that a route that the navigation system of the vehicle is intending to follow may be associated with poor cellular communication performance, for example due to a transient cell site outage, due to poor weather, or due to excessive subscriber communication traffic. Because the system is both collecting data from the vehicle (as well as other vehicles concurrently) and transmitting control recommendations in near real-time to the vehicle, it is desirable that the vehicle remain in areas able to provide high quality cellular communication service at that particular instant in time. By recommending a different driving route, based on the network's current performance, the system may provide better real-time or near real-time monitoring of vehicle operating parameters and road conditions as well as better real-time or near real-time transmission of control recommendations to the vehicle. It is understood that the system may analyze a large amount of data received from other vehicles and from the network over extended periods of time and from this analysis anticipate conditions in the cellular network along a given projected vehicle navigation route and also anticipate conditions in the cellular network along one or more alternative routes. In some cases, the system may command the cellular network to hand-over the vehicle (e.g., the cellular communication link of a telematics unit of the vehicle) to an alternative cell tower based on knowledge of the destination of the vehicle and based on its understanding of current network communication loading.

In an embodiment, health and/or physical condition of a driver of a vehicle may be monitored by the system, and the system may send control recommendations to the vehicle accordingly. For example, the telematics system in a vehicle may be able to sense a driver's eyes drooping closed as if the driver is severely fatigued and transmit this information to the system, and the system may accordingly send a lowered speed and/or acceleration recommendation to the vehicle over the cellular network. The telematics system may be able to sense a blood sugar level of a driver and transmit this information to the system, and the system may accordingly send lowered speed and/or acceleration recommendations to the vehicle over the cellular network.

In an embodiment, a telematics unit in a semi-truck rig may upload truck capabilities and upload a shipping manifest to the system. The system can analyze the capabilities of the truck, analyze the manifest, and recommend a navigation route based, at least partly, on the shipping manifest. For example, if the manifest indicates the truck is a refrigerated truck, the system may recommend the truck take a route that avoids hot outdoors temperatures and/or avoids areas where long traffic jams may occur. This can help the truck operate efficiently and also bring its produce to market in top condition.

The system provides a particular technical solution to the technical problem of operating motor vehicles efficiently and safely. The solution depends upon using a radio access network (RAN) of a cellular communication network to collect data from different motor vehicles across a wide variety of locations and regions. The system then uses historical data to recognize patterns and make inferences that it uses to augment the control of the vehicle. In an embodiment, the system builds and dynamically trains a machine learning model using information collected from multiple sources including vehicle operating parameters and road conditions received from vehicles (e.g., from telematics units in vehicles) over a RAN. This system can then enable inferences to be made based on real-time or near-real time information received from specific vehicles via the RAN and to send augmented control recommendations and/or commands to the specific vehicles.

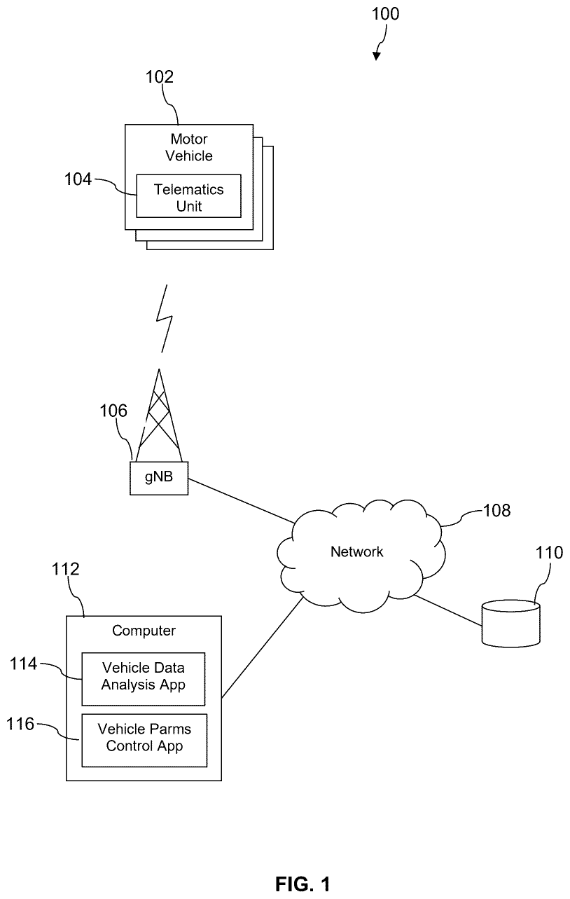

Turning now to FIG. 1, a system 100 is described. In an embodiment, the system 100 comprises a plurality of motor vehicles 102, wherein each motor vehicle 102 comprises a telematics unit 104. Each telematics unit 104 comprises a computer system including a cellular radio transceiver. Computer systems are described further hereinafter. The telematics unit 104 may communicate with various vehicle systems within the motor vehicle 102, for example with an engine control unit, a transmission control unit, an anti-skid braking system unit, a sound system control unit, a navigation system unit, a central display panel, and the cellular radio transceiver. The telematics unit 104 may receive data from the various vehicle systems and also transmit one or more control signals to the various vehicle systems. The telematics unit 104 may set one or more operational limits of the various vehicle systems. The telematics unit 104 may receive signals from sensors distributed about the motor vehicle 102. The motor vehicles 102 may be a mix of different type of vehicles. Some of the motor vehicles 102 may be automobiles, sport utility vehicles, pickup trucks, mini-vans, delivery vans, delivery trucks, semi-trucks (e.g., 18-wheelers or tractor-trailer combinations), concrete mixer trucks, service trucks, and the like.

The cellular radio transceiver of each of the telematics units 104 is able to establish a cellular radio link with a cell site 106 according to a 5G, a long-term evolution (LTE), a code division multiple access (CDMA), or a global system for mobile communications (GSM) telecommunications protocol. While FIG. 1 shows a single cell site 106, it is understood that the system 100 comprises any number of cell sites and that a nation-wide radio access network (RAN) may comprise tens of thousands or even hundreds of thousands of cell sites 106. The cell site 106 provides a communication link from the telematics unit 104 to a network 108 and from the network 108 to the data store 110 and to a computer system 112. The telematics units 104 may transmit various data from the motor vehicles 102 to the data store 110 for storage. The network 108 comprises one or more public networks, one or more private networks, or a combination thereof.

The computer system 112 may execute a vehicle data analysis application 114 and a vehicle parameters control application 116. The vehicle data analysis application 114 may analyze the data uploaded from the telematics units 104 to the data store 110 and train machine learning (ML) models with this data. The vehicle parameters control application 116 may use current conditions data from one or more of the motor vehicles 102 and also data of an environment of the motor vehicles (e.g., weather information, road traffic congestion information, and RAN congestion proximate the motor vehicles) along with the ML model to generate a control recommendation or vehicle operation parameter. The vehicle parameters control application 116 may transmit the generated control recommendation to the telematics unit 104 of one of the motor vehicles 102, whereby the vehicle parameters control application provides augmented control for the subject vehicle 102.

In an embodiment, other information is uploaded to the data store 110 from sources other than the telematics units 104, for example from temperature monitor stations, from humidity monitor stations, from barometric pressure monitor stations, and from current weather monitor stations. In an embodiment, information about roadway traffic flows and traffic congestion are uploaded to the data store 110 from sources other than the telematics units 104. In an embodiment, information about RAN conditions is uploaded to the data store 110 from cell sites 106 and gateways within the network 108.

The data transmitted from the telematics unit 104 of each motor vehicle 102 to the data store 110 may comprise anti-skid information, vehicle velocity information, vehicle angular velocity or turning rate information, gearing information, engine RPM information, wheel torque information, and the like. The data transmitted from the telematics unit 104 of each motor vehicle 102 to the data store 110 may comprise information about distance from another vehicle in front of the subject vehicle, information about distance from another vehicle in back of the subject vehicle, information about distance from a left lane marker of the subject vehicle, and information about distance from a right lane marker of the subject vehicle. The data transmitted from the telematics unit 104 of each motor vehicle 102 to the data store 110 may comprise outside temperature, outside humidity, and an indication of precipitation. The data transmitted from the telematics unit 104 of each motor vehicle 102 may indicate a make and model, an engine power rating, and transmission and/or drive train configuration information of the subject vehicle. The data transmitted from the telematics unit 104 of each motor vehicle 102 may comprise information about a driving destination and/or intended navigation route of the subject vehicle. The data transmitted from the telematics unit 104 of each motor vehicle 102 may comprise information about its attachment to the cell site 106—an identity of the cell site, an uplink channel bandwidth, a downlink channel bandwidth, a cell site congestion factor, and other radio related information. The cell site congestion factor may be an indication of how loaded the cell site is. For example, if a cell site supports 20 channels and 15 are currently assigned to subscribers making calls, the cell site congestion factor may be 0.75, where 1.0 is a maximum and 0.0 is a minimum value of the cell site congestion factor.

The data transmitted from the telematics unit 104 of some motor vehicles 102 may comprise a lading manifest, for example of list of products carried in a trailer of a semi-trailer vehicle. The lading manifests may, at least in some instances, comprise state information such as a date the products were loaded onto the trailer. The lading manifest may, at least in some instances, comprise a set of environmental parameters that it is desired to maintain while the products are loaded within the trailer, for example temperature limits for fresh produce.

The data transmitted by the telematics units 104 to the data store 110 may be analyzed by the vehicle data analysis application 114 to train a plurality of different machine learning (ML) models. This may be referred to in some contexts as analyzing historical information about motor vehicles 102 because the analyzed information extends from the near past (e.g., a day ago, a week ago, a month ago) into a more distant past (e.g., three months ago, six months ago, a year ago, two years ago, three years ago, or some other point in the past). The vehicle data analysis application 114 may also train the plurality of ML models based on the environmental and weather information stored in the data store 110 and based on the RAN information stored in the data store 110.

The vehicle data analysis application 114 may periodically retrain the plurality of ML models, whereby to make use of recently stored in the data store 110. In an embodiment, the vehicle data analysis application 114 periodically retrains the plurality of ML models weekly, monthly, quarterly, twice a year, yearly, or on some other periodic basis. In an embodiment, the vehicle data analysis application 114 analyzes a recent rolling block of data stored in the data store 110. For example, if the data store 110 comprises 3 years of data, the vehicle data analysis application 114 may analyze only the most recent 18 months of data, the most recent 12 months of data, the most recent 6 months of data, or some other recent period of time. When the vehicle data analysis application 114 re-executes, for example one month later, the vehicle data analysis application 114 only uses the predefined recent block of data (e.g., 18 month block, 12 month block, 6 month block, or other length block). In an embodiment, the vehicle data analysis application 114 begins a retraining cycle from the previously trained ML models as a starting point and only uses the data collected since the previous training of the ML models to adapt the ML models.

The trained ML models and updated versions of the trained ML models (e.g., ML models that have been updated based on continuously incoming training data) may be stored in the data store 110 or may be retained within the vehicle data analysis application 114 and/or the computer system 112. The vehicle data analysis application 114 may generate multiple distinct ML models because it may be desirable to pose a different query to different ML models. For example, a query from the vehicle parameters control application 116 about a best navigational route for a private passenger car may be posed to a first ML model while a query from the vehicle parameters control application 116 about a best navigational route for a semi-trailer carrying high-value perishable produce may be posed to a second different ML model.

The vehicle parameters control application 116 can receive current data from the telematics unit 104 of a specific motor vehicle 102 or access this same current data from the data store 110. The vehicle parameters control application 116 can input at least some of the current data associated with the specific motor vehicle 102 to a ML model associated with the type of motor vehicle 102 and/or associated with a particular type of query, and the ML model can return one or more recommended vehicle parameters to the vehicle parameters control application 116. The vehicle parameters control application 116 can also input current conditions of the RAN within a 2 mile radius, a 5 mile radius, a 7 mile radius, a 10 mile radius, or a 15 mile radius of the subject motor vehicle 102 into the ML model. The vehicle parameters control application 116 can also input a currently intended navigational route of the subject motor vehicle 102 to the ML model.

The subject motor vehicle 102 can update one or more of its systems with recommended vehicle control parameters received from the vehicle parameters control application 116. In this way, the system 100 and the vehicle parameters control application 116 can provide augmented control of the subject vehicle 102. This can include routing the subject motor vehicle 102 along a roadway route suggested by the vehicle parameters control application 116 that keeps the motor vehicle 102 in good cellular radio coverage, for example along a route proximate to cell sites 106 that are not currently overloaded with attached cellular links to other subscribers. This can assure that the motor vehicle 102 is able to benefit from the augmented control functionality provided by the system 100. If, by contrast, the motor vehicle 102 instead routes through an area experiencing cellular communication congestion, the system 100 may not be able to provide timely control augmentation inputs because of RAN traffic congestion. In some instances, a navigational route for the subject motor vehicle 102 may be suboptimal from point of view of minimizing time to reach the destination, minimizing distance driven to reach the destination, and/or minimizing fuel consumed to reach the destination while still optimizing connectivity of the telematics unit 104 to the RAN and therefore assuring optimal control augmentation from the system 100 and/or the vehicle parameters control application.

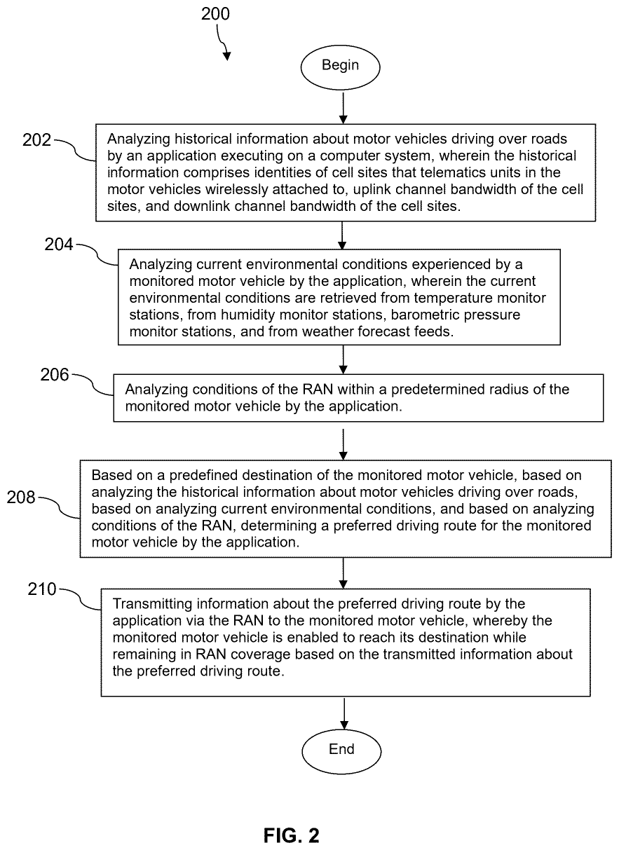

Turning now to FIG. 2, a method 200 is described. In an embodiment, the method 200 is a method of augmenting control of a motor vehicle based on driving conditions and conditions of a radio access network (RAN). At block 202, the method 200 comprises analyzing historical information about motor vehicles driving over roads by an application executing on a computer system, wherein the historical information comprises identities of cell sites that telematics units in the motor vehicles wirelessly attached to, uplink channel bandwidth of the cell sites, and downlink channel bandwidth of the cell sites. In an embodiment, the motor vehicles are a mix of automobiles, sport utility vehicles, pickup trucks, mini-vans, delivery vans, delivery trucks, semi-trucks, concrete mixer trucks, and service trucks.

At block 204, the method 200 comprises analyzing current environmental conditions experienced by a monitored motor vehicle by the application, wherein the current environmental conditions are retrieved from temperature monitor stations, from humidity monitor stations, barometric pressure monitor stations, and from weather forecast feeds. At block 206, the method 200 comprises analyzing conditions of the RAN within a predetermined radius of the monitored motor vehicle by the application. In an embodiment, the predetermined radius may be a 10 mile radius. In an embodiment, the predetermined radius may be a 2 mile radius, a 5 mile radius, a 7 mile radius, a 10 mile radius, or a 15 mile radius.

At block 208, the method 200 comprises, based on a predefined destination of the monitored motor vehicle, based on analyzing the historical information about motor vehicles driving over roads, based on analyzing current environmental conditions, and based on analyzing conditions of the RAN, determining a preferred driving route for the monitored motor vehicle by the application. At block 210, the method 200 comprises transmitting information about the preferred driving route by the application via the RAN to the monitored motor vehicle, whereby the monitored motor vehicle is enabled to reach its destination while remaining in RAN coverage based on the transmitted information about the preferred driving route. In an embodiment, the application transmits the information about the preferred driving route to a telematics unit of the monitored motor vehicle, for example from the computer system 112, to the network 108, to the cell site 106 and via a cellular radio link to the telematics unit 104 in the monitored motor vehicle 102. In an embodiment, the method 200 further comprises receiving information about motor vehicles (e.g., motor vehicles 102) by a cell site of the RAN (e.g., cell site 106) and storing the information about motor vehicles received by the cell site in a data store (e.g., data store 110), whereby historical information about motor vehicles is accumulated.

In an embodiment, the method 200 further comprises, based on analyzing the historical information about motor vehicles driving over roads and based on analyzing current environmental conditions, determining a vehicle control parameter by the application and transmitting the vehicle control parameter by the application to the monitored motor vehicle. In an embodiment, the vehicle control parameter comprises a maximum wheel torque recommendation (e.g., a maximum drive wheel torque recommendation). In an embodiment, the vehicle control parameter comprises a minimum vehicle separation recommendation. In an embodiment, the vehicle control parameter comprises a maximum engine RPM and a gear recommendation.

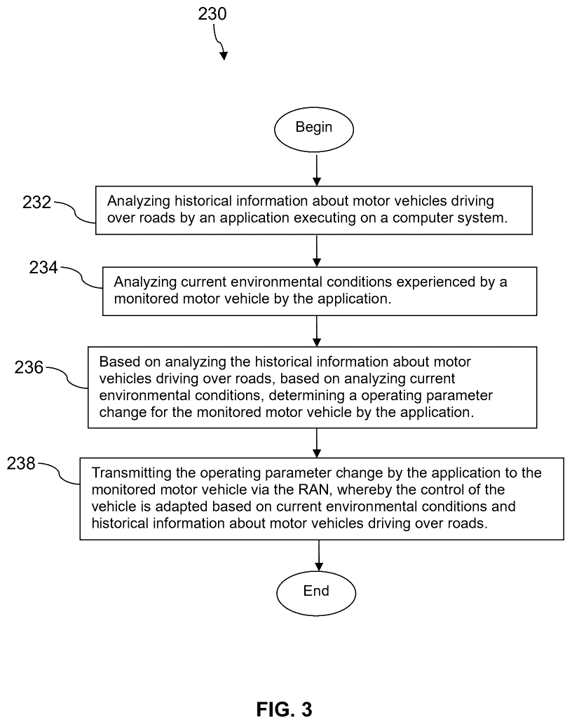

Turning now to FIG. 3, a method 230 is described. In an embodiment, the method 230 is a method of augmenting control of a motor vehicle based on driving conditions and conditions of a radio access network (RAN). At block 232, method 230 comprises analyzing historical information about motor vehicles driving over roads by an application executing on a computer system.

At block 234, the method 230 comprises analyzing current environmental conditions experienced by a monitored motor vehicle by the application. At block 236, method 230 comprises, based on analyzing the historical information about motor vehicles driving over roads, based on analyzing current environmental conditions, determining an operating parameter change for the monitored motor vehicle by the application. In an embodiment, the monitored motor vehicle is herein one of an automobile, a sport utility vehicle, a pickup truck, a mini-van, a delivery van, a delivery truck, a semi-truck, a concrete mixer truck, and a service truck. In an embodiment, the operating parameter change is associated with a changed maximum vehicle speed limit. In an embodiment, the operating parameter change is associated with a changed wheel torque limit. In an embodiment, the operating parameter change is associated with a vehicle separation minimum. In an embodiment, the operating parameter change comprises an engine RPM limit and a drive gear recommendation.

At block 238, the method 230 comprises transmitting the operating parameter change by the application to the monitored motor vehicle via the RAN, whereby the control of the vehicle is adapted based on current environmental conditions and historical information about motor vehicles driving over roads.

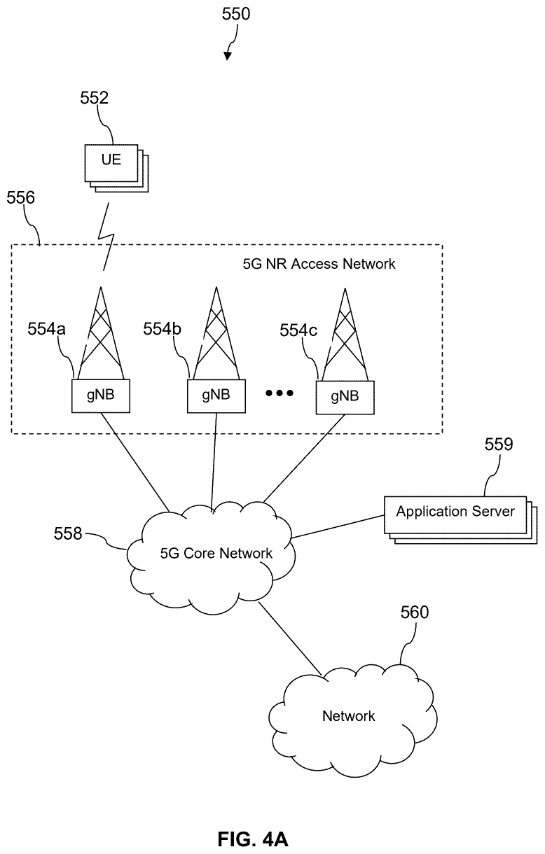

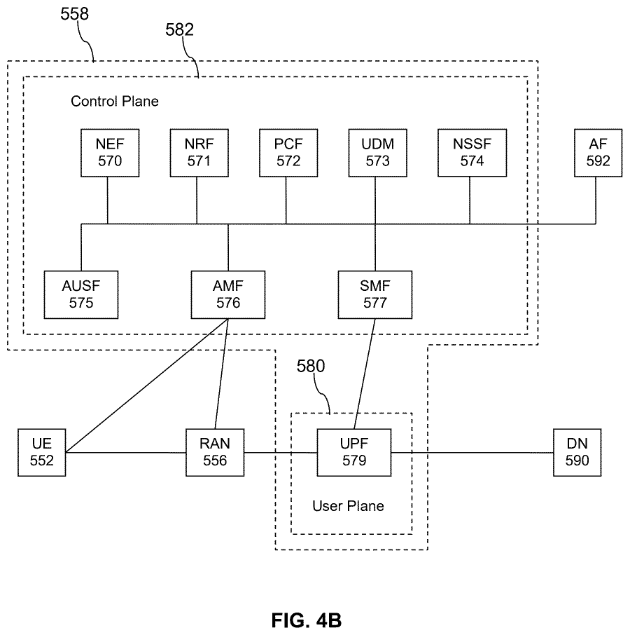

Turning now to FIG. 4A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts.

In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IOT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 4B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 4A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

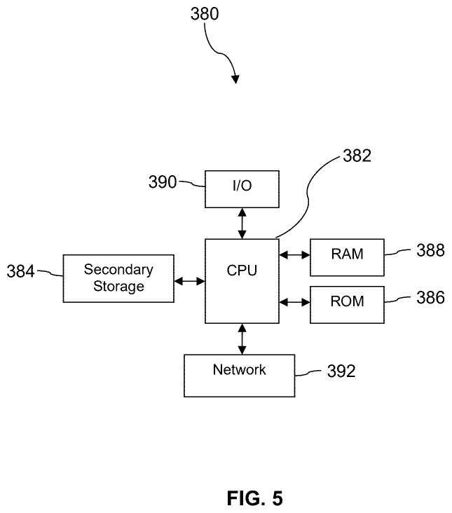

FIG. 5 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of augmenting control of a motor vehicle based on driving conditions and conditions of a radio access network (RAN), comprising:
analyzing historical information about motor vehicles driving over roads by an application executing on a computer system, wherein the historical information comprises identities of cell sites that telematics units in the motor vehicles wirelessly attached to, uplink channel bandwidth of the cell sites, and downlink channel bandwidth of the cell sites;
analyzing current environmental conditions experienced by a monitored motor vehicle by the application, wherein the current environmental conditions are retrieved from temperature monitor stations, from humidity monitor stations, barometric pressure monitor stations, and from weather forecast feeds;
analyzing conditions of the RAN within a predetermined radius of the monitored motor vehicle by the application;
based on a predefined destination of the monitored motor vehicle, based on analyzing the historical information about motor vehicles driving over roads, based on analyzing current environmental conditions, and based on analyzing conditions of the RAN, determining a preferred driving route for the monitored motor vehicle by the application; and
transmitting information about the preferred driving route by the application via the RAN to the monitored motor vehicle, whereby the monitored motor vehicle is enabled to reach its destination while remaining in RAN coverage based on the transmitted information about the preferred driving route.

2. The method of claim 1, wherein the motor vehicles are a mix of automobiles, sport utility vehicles, pickup trucks, mini-vans, delivery vans, delivery trucks, semi-trucks, concrete mixer trucks, and service trucks.

3. The method of claim 1, wherein the application transmits information about the preferred driving route to a telematics unit of the monitored motor vehicle.

4. The method of claim 1, further comprising receiving information about motor vehicles by a cell site of the RAN and storing the information about motor vehicles received by the cell site in a data store, whereby historical information about motor vehicles is accumulated.

5. The method of claim 1, further comprising, based on analyzing the historical information about motor vehicles driving over roads and based on analyzing current environmental conditions, determining a vehicle control parameter by the application and transmitting the vehicle control parameter by the application to the monitored motor vehicle.

6. The method of claim 5, wherein the vehicle control parameter comprises a maximum wheel torque recommendation.

7. The method of claim 5, wherein the vehicle control parameter comprises a minimum vehicle separation recommendation.

8. A system for augmenting control of a motor vehicle based on driving conditions and radio access network (RAN) conditions, comprising:
a processor;
a non-transitory memory; and
an application stored in the non-transitory memory that, when executed by the processor:
analyzes historical information about motor vehicles driving over roads by an application executing on a computer system;
analyzes current environmental conditions experienced by a monitored motor vehicle by the application;
analyzes radio access network (RAN) conditions by the application, wherein the RAN conditions comprise a plurality of RAN conditions at each of a plurality of cell sites, wherein the RAN conditions comprise two or more of an uplink channel bandwidth, a downlink channel bandwidth, and a cell site congestion factor;
based on a predefined destination of the monitored motor vehicle, based on analyzing the historical information about motor vehicles driving over roads, based on analyzing current environmental conditions, and based on analyzing RAN conditions, determines a preferred driving route for the monitored motor vehicle by the application; and
transmits information about the preferred driving route by the application via the RAN to the monitored motor vehicle, whereby the monitored motor vehicle is enabled to reach its destination while remaining in RAN coverage.

9. The system of claim 8, wherein the historical information about motor vehicles comprises anti-skid information.

10. The system of claim 8, wherein the historical information about motor vehicles comprises gearing information.

11. The system of claim 8, wherein the historical information about motor vehicles comprises information about vehicle angular velocity.

12. The system of claim 8, wherein the application transmits the information about the preferred driving route to a telematics unit of the monitored motor vehicle.

13. The system of claim 12, wherein the application transmits the information about the preferred driving route to the telematics unit via a cell site of the RAN.

14. The system of claim 13, wherein the cell site establishes a wireless communication link with the telematics unit of the monitored motor vehicle according to a 5G, a long-term evolution (LTE), a code division multiple access (CDMA), or a global system for mobile communications (GSM) telecommunication protocol.

15. A method comprising:
analyzing historical information about motor vehicles driving over roads by an application executing on a computer system;
analyzing current environmental conditions experienced by a monitored motor vehicle by the application;
based on analyzing the historical information about motor vehicles driving over roads, based on analyzing current environmental conditions, determining an operating parameter change for the monitored motor vehicle by the application; and
transmitting the operating parameter change by the application to the monitored motor vehicle via a network, whereby the control of the vehicle is adapted based on current environmental conditions and historical information about motor vehicles driving over roads.

16. The method of claim 15, wherein the operating parameter change is associated with a changed maximum vehicle speed limit.

17. The method of claim 15, wherein the operating parameter change is associated with a changed wheel torque limit.

18. The method of claim 15, wherein the operating parameter change is associated with a vehicle separation minimum.

19. The method of claim 15, wherein the operating parameter change comprises an engine RPM limit and a drive gear recommendation.

20. The method of claim 15, wherein the monitored motor vehicle is one of an automobile, a sport utility vehicle, a pickup truck, a mini-van, a delivery van, a delivery truck, a semi-truck, a concrete mixer truck, and a service truck.
